(19) United States
(12) Patent Application Publication
(10) Pub. No.: US 2012/0251916 A1
(43) Pub. Date: Oct. 4, 2012

(54) FUEL CELL UNIT

(75) Inventors: Yueh-Chang Wu, Hsinchu County (TW); Chih-Lin Ho, Hsinchu County (TW); Hsuan-Yi Lu, Hsinchu County (TW); Chun-Yi Wu, Hsinchu County (TW)

(73) Assignee: YOUNG GREEN ENERGY CO., Hsinchu County (TW)

(21) Appl. No.: 13/404,003

(22) Filed: Feb. 24, 2012

(30) Foreign Application Priority Data
Apr. 1, 2011 (CN) 201110086643.9

(51) Int. Cl. H01M 8/10

(52) U.S. Cl. 429/480; 429/482

(57) ABSTRACT

A fuel cell unit including a membrane electrode assembly (MEA), a cathode collector plate, an anode collector plate, and a plurality of ribs is provided. The cathode collector plate is disposed at one side of the membrane electrode assembly. The anode collector plate is disposed at another side of the membrane electrode assembly. A material of the anode collector plate may be metal. The ribs are respectively disposed on the anode collector plate. A material of the ribs may be metal. The ribs and the anode collector slate form a plurality of gas channels for supplying a reaction gas to the membrane electrode assembly.

### CROSS-REFERENCE TO RELATED APPLICATION

This application claims the priority benefit of China application serial no. 201110086643.9, filed Apr. 1, 2011. The entirety of the above-mentioned patent application is hereby incorporated by reference herein and made a part of this specification.

### BACKGROUND OF THE INVENTION

1. Field of the Invention

The invention generally relates to a fuel cell, and more particularly, to a fuel cell unit.

2. Description of Related Art

The exploitation and application of natural resources have always been a very crucial part of human life but have also brought many damages to the environment. The fuel cell technology offers a highly efficient, low-noise, and nonpolluting way to generate energy, and therefore is a very promising energy technology. The most commonly used fuel cells include proton exchange membrane fuel cells (PEMFC) and direct methanol fuel cells (DMFC).

In a PEMFC, a stream of hydrogen is delivered to the anode to react with a catalyst, so as to generate protons and electrons, wherein the electrons are conducted from the anode to the cathode through a circuit, while the hydrogen ions pass through a proton exchange membrane (PEM) to reach the cathode and react with the electrons and oxygen to generate water.

A PEM-type fuel cell unit usually includes a membrane electrode assembly (MEA), a cathode collector net, an anode collector net, an oxygen channel plate, and a hydrogen channel plate, and these components are sequentially stacked together. However, since each of these components has a certain thickness, the thickness of the entire fuel cell unit cannot be reduced.

A collector plate with a channel structure is respectively disclosed in U.S. Pat. No. 5,879,826, Taiwan Patent Publication No. 200838018 and Taiwan Patent No. 1311829. In addition, a surface mount technology (SMT) for adhering an electronic element or a fuel cell unit is disclosed in U.S. Patent Publication Nos. 2007/0099041 and 2004/0033404.

### SUMMARY OF THE INVENTION

Accordingly, the invention is directed to a fuel cell unit with high structural strength and reduced fabrication cost.

Additional aspects and/or advantages of the invention will be set forth in part in the description which follows and, in part, will be obvious from the description, or may be learned by practice of the invention.

According to an embodiment of the invention, a fuel cell unit including a membrane electrode assembly (MEA), a cathode collector plate, an anode collector plate, and a plurality of ribs is provided. The cathode collector plate is disposed at one side of the membrane electrode assembly. The anode collector plate is disposed at the opposite side of the membrane electrode assembly. A material of the anode collector plate may be metal. The ribs are respectively disposed on the anode collector plate. A material of the ribs may be metal. The ribs and the anode collector plate form a plurality of gas channels for supplying a reaction gas to the membrane electrode assembly.

In one embodiment of the invention, the ribs are respectively welded or adhered to the anode collector plate.

In one embodiment of the invention, the ribs respectively touch the membrane electrode assembly.

In one embodiment of the invention, the fuel cell unit further includes an insulation layer and a clamping element. The insulation layer surrounds the membrane electrode assembly and is located between the cathode collector plate and the anode collector plate. The clamping element clamps the cathode collector plate, the insulation layer, and the anode collector plate.

In one embodiment of the invention, the clamping element includes a first clamping portion and a second clamping portion. The first clamping portion surrounds the exterior of the cathode collector plate. The second clamping portion surrounds the exterior of the anode collector plate, and connects with the first clamping portion to clamp the cathode collector plate, the anode collector plate, and the insulation layer located between the cathode collector plate and the anode collector plate.

In one embodiment of the invention, a material of the first clamping portion and the second clamping portion is plastic.

In one embodiment of the invention, the cathode collector plate touches the membrane electrode assembly.

In one embodiment of the invention, a material of the cathode collector plate may be metal.

In one embodiment of the invention, the cathode collector plate has a plurality of through holes for supplying the reaction gas to the membrane electrode assembly.

In one embodiment of the invention, the fuel cell unit further includes a printed circuit board (PCB), and the anode collector plate and the printed circuit board are adhered together through a surface mount technology (SMT).

As described above, in at least one embodiment of the invention, a material of the anode collector plate and the ribs is metal so that the structural strength of the fuel cell unit is enhanced. In addition, the ribs are separately fabricated and respectively disposed on the anode collector plate so that the fabrication of the fuel cell unit is simplified and the fabrication cost is reduced.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a fuel cell unit according to an embodiment of the invention.

FIG. 2 is a partial perspective view of the fuel cell unit in FIG. 1.

FIG. 3 is a cross-sectional view of a fuel cell unit according to another embodiment of the invention.

FIG. 4 is a partial perspective view of the fuel cell unit in FIG. 3.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

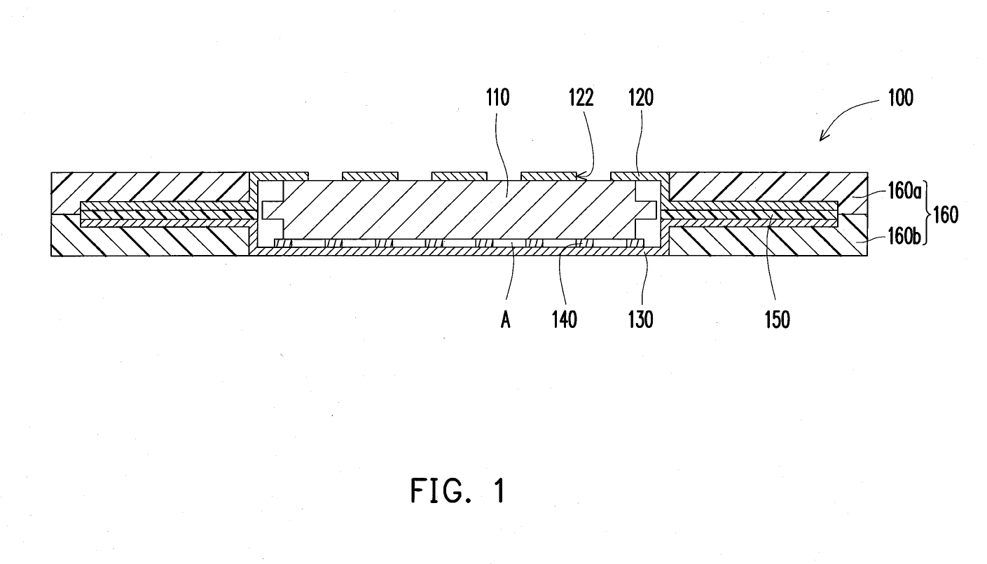

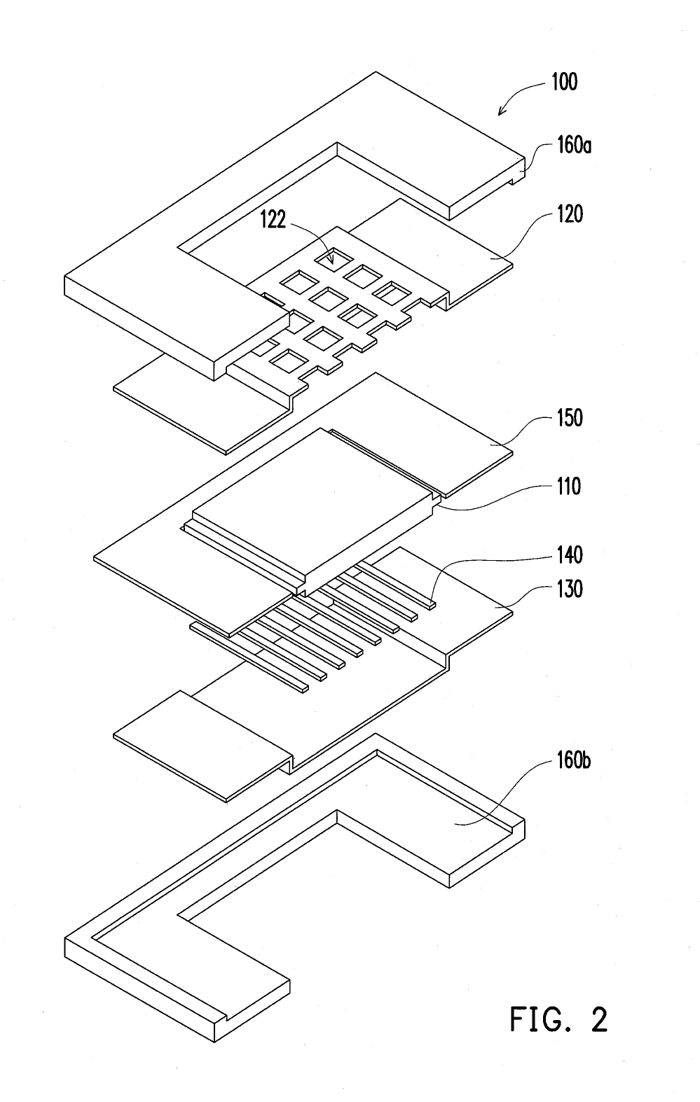

FIG. 1 is a cross-sectional view of a fuel cell unit according to an embodiment of the invention, and FIG. 2 is a partial perspective view of the fuel cell unit in FIG. 1. Referring to FIG. 1 and FIG. 2, the fuel cell unit 100 in the embodiment is a proton exchange membrane fuel cell (PEMFC). In the embodiment, the fuel cell unit 100 includes a membrane electrode assembly (MEA) 110, a cathode collector plate 120, an anode collector plate 130, and a plurality of ribs 140.

The membrane electrode assembly 110 includes a proton exchange membrane (PEM) and two catalyst layers, two gas diffusion layers respectively located at both sides of the proton exchange membrane, and the membrane electrode assembly 110 further includes two sealing pads respectively located at the edges of both sides of the proton exchange membrane. Because the membrane electrode assembly 110 has many different component selections and combinations, the components of the membrane electrode assembly 110 are not limited in the invention.

The cathode collector plate 120 is disposed at one side of the membrane electrode assembly 110 and touches the membrane electrode assembly 110. In the embodiment, a material of the cathode collector plate 120 may be metal, and the cathode collector plate 120 has a plurality of through holes 122 for supplying a reaction gas (for example, oxygen) to the membrane electrode assembly 110. In practical application, in order to supply the reaction gas to the membrane electrode assembly 110 more efficiently, the through holes 122 may be arranged in a predetermined pattern or at predetermined intervals.

The anode collector plate 130 is disposed at another side of the membrane electrode assembly 110, and a material of the anode collector plate 130 may be metal. The ribs 140 are respectively disposed on the anode collector plate 130 and touch the membrane electrode assembly 110, and a material of the ribs 140 may be metal. The ribs 140 and the anode collector plate 130 form a gas channel A (as shown in FIG. 1, multiple gas channels are formed in the embodiment) for supplying a reaction gas (for example, hydrogen) to the membrane electrode assembly 110. In the embodiment, because the anode collector plate 130 and the ribs 140 may be made of metal, the ribs 140 are respectively welded or adhered to the anode collector plate 130 through a surface mount technology (SMT) so that the ribs 140 are electrically connected to the anode collector plate 130. Additionally, in the embodiment, because the gas channels A are formed by the ribs 140 and the anode collector plate 130, it is not necessary to fabricate a channel plate for the fuel cell unit 100. Accordingly, the fabrication cost of the fuel cell unit 100 is reduced and the fuel cell unit 100 is more slim and light.

In the embodiment, the fuel cell unit 100 further includes an insulation layer 150 and a clamping element 160. The insulation layer 150 surrounds the membrane electrode assembly 110 and is located between the cathode collector plate 120 and the anode collector plate 130. The clamping element 160 clamps the cathode collector plate 120 and the anode collector plate 130 to fix the relative positions of the cathode collector plate 120, the anode collector plate 130, and the insulation layer 150. It should be noted that for the convenience of description, only a partial (not complete) perspective view of the fuel cell unit 100 is illustrated in FIG. 2.

In the embodiment, the clamping element 160 includes a first clamping portion 160a and a second clamping portion 160b. The first clamping portion 160a surrounds the exterior of the cathode collector plate 120, and the second clamping portion 160b surrounds the exterior of the anode collector plate 130 and connects with the first clamping portion 160a to clamp the cathode collector plate 120, the anode collector plate 130, and the insulation layer 150 located between the cathode collector plate 120 and the anode collector plate 130. The first clamping portion 160a may be connected with the second clamping portion 160b through glue bonding or thermo-compression bonding. Additionally, the first clamping portion 160a and the second clamping portion 160b may be made of plastic such that the first clamping portion 160a and the second clamping portion 160b could be fabricated through injection molding.

When the embodiment is implemented, because the anode collector plate 130 is made of a metal material, a printed circuit board (not shown) may be adhered to the exterior of the anode collector plate 130 through SMT without any connector, so that the size, weight, and fabrication cost of the fuel cell unit could be further reduced.

Moreover, the way that the second clamping portion surrounds the anode collector plate is not limited to the embodiment illustrated in FIG. 2. In the embodiment illustrated in FIG. 2, the second clamping portion 160b has an opening each half of which presents a “[” shape, and the anode collector plate 130 is placed inside the opening. In other embodiments, the second clamping portion may further carry the anode collector plate besides surrounding the anode collector plate.

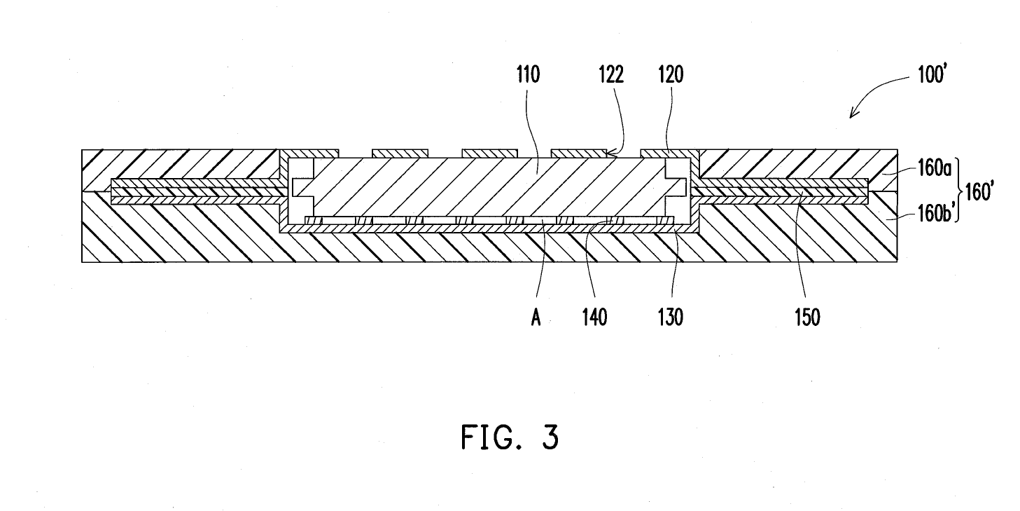

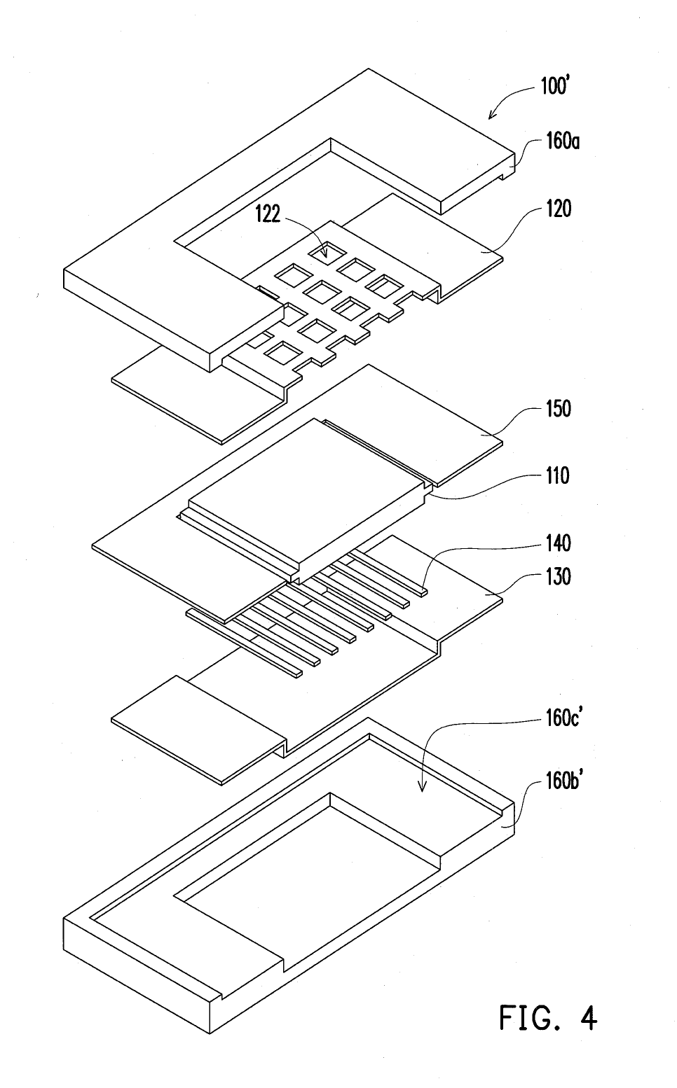

FIG. 3 is a cross-sectional view of a fuel cell unit according to another embodiment of the invention, and FIG. 4 is a partial perspective view of the fuel cell unit in FIG. 3. Referring to FIG. 3 and FIG. 4, in the fuel cell unit 100′, the second clamping portion 160b′ of the clamping element 160′ has a recessed portion 160c′ for placing the anode collector plate 130, such that the anode collector plate 130 is carried on the second clamping portion 160b′ and surrounded by the outmost part of the recessed portion 160c′.

In summary, in foregoing embodiments of the invention, the anode collector plate and the ribs are made of metal materials such that the structural strength of the fuel cell unit is enhanced. In addition, the ribs are separately fabricated and then respectively disposed on the anode collector plate so that the fabrication process of the fuel cell unit is simplified and accordingly the fabrication cost thereof is reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell unit, comprising:
a membrane electrode assembly;
a cathode collector plate disposed at one side of the membrane electrode assembly;
an anode collector plate disposed at an opposite side of the membrane electrode assembly, wherein a material of the anode collector plate comprises metal; and
a plurality of ribs respectively disposed on the anode collector plate and facing the membrane electrode assembly, wherein a material of the ribs comprises metal, and the ribs and the anode collector plate form a plurality of gas channels for supplying a reaction gas to the membrane electrode assembly.

2. The fuel cell unit according to claim 1, wherein the ribs are respectively welded or adhered to the anode collector plate.

3. The fuel cell unit according to claim 1, wherein the ribs respectively touch the membrane electrode assembly.

4. The fuel cell unit according to claim 1 further comprising:
an insulation layer surrounding the membrane electrode assembly and located between the cathode collector plate and the anode collector plate; and
a clamping element clamping the cathode collector plate, the insulation layer, and the anode collector plate.

5. The fuel cell unit according to claim 4, wherein the clamping element comprises:
a first clamping portion surrounding an exterior of the cathode collector plate; and
a second clamping portion surrounding an exterior of the anode collector plate and connecting with the first clamping portion to clamp the cathode collector plate, the anode collector plate, and the insulation layer located between the cathode collector plate and the anode collector plate.

6. The fuel cell unit according to claim 5, wherein a material of the first clamping portion and the second clamping portion is plastic.

7. The fuel cell unit according to claim 1, wherein the cathode collector plate touches the membrane electrode assembly.

8. The fuel cell unit according to claim 1, wherein a material of the cathode collector plate comprises metal.

9. The fuel cell unit according to claim 1, wherein the cathode collector plate has a plurality of through holes for supplying the reaction gas to the membrane electrode assembly.
